(19) United States
(12) Patent Application Publication
(10) Pub. No.: US 2009/0216535 A1
(43) Pub. Date: Aug. 27, 2009

(54) Engine For Speech Recognition

(76) Inventors: Avraham Entlis, Rehovot (IL); Adam Simone, Rehovot (IL); Rabin Cohen-Tov, Halale Dakar (IL); Izhak Meller, Rehovot (IL); Roman Budovnich, Rotshild (IL); Shlomi Bognim, Beer Sheva (IL)

Correspondence Address: The Law Office of Michael E. Kondoudis, PC, 888 16th Street, N.W., Suite 800, Washington, DC, 20006, US

(21) Appl. No.: 12/035,715

(22) Filed: Feb. 22, 2008

(51) Int. Cl. G10L 15/04

(52) U.S. Cl. 704/254; 704/E15.003; 704/E15.045

(57) ABSTRACT

A computerized method for speech recognition in a computer system. Reference word segments are stored in memory. The reference word segments when concatenated form spoken words in a language. Each of the reference word segments is a combination of at least two phonemes, including a vowel sound in the language. A temporal speech signal is input and digitized to produced a digitized temporal speech signal The digitized temporal speech signal is transformed piecewise into the frequency domain to produce a time and frequency dependent transform function. The energy spectral density of the temporal speech signal is proportional to the absolute value squared of the transform function. The energy spectral density is cut into input time segments of the energy spectral density. Each of the input time segments includes at least two phonemes including at least one vowel sound of the temporal speech signal. For each of the input time segments, (i) a fundamental frequency is extracted from the energy spectral density during the input time segment, (ii) a target segment is selected from the reference segments and thereby a target energy spectral density of the target segment is input. A correlation between the energy spectral density during the time segment and the target energy spectral density of the target segment is performed after calibrating the fundamental frequency to the target energy spectral density thereby improving the correlation.

### FIELD AND BACKGROUND OF THE INVENTION

The present invention relates to speech recognition and, more particularly, to the conversion of an audio speech signal to readable text data. Specifically, the present invention includes a method which improves speech recognition performance.

In prior art speech recognition systems, a speech recognition engine typically incorporated into a digital signal processor (DSP), inputs a digitized speech signal, and processes the speech signal by comparing its output to a vocabulary found in a dictionary. The speech signal is input into a circuit including a processor which performs a Fast Fourier transform (FFT) using any of the known FFT algorithms. After performing FFT, the frequency domain data is generally filtered, e.g. Mel filtering to correspond to the way human speech is perceived. A sequence of coefficients are used to generate voice prints of words or phonemes based on Hidden Markov Models (HMMs). A hidden Markov model (HMM) is a statistical model where the system being modeled is assumed to be a Markov process with unknown parameters, and the challenge is to determine the hidden parameters, from the observable parameters. Based on this assumption, the extracted model parameters can then be used to perform speech recognition. Having a model which gives the probability of an observed sequence of acoustic data given a word phoneme or word sequence enables working out the most likely word sequence.

In human language, the term “phoneme” as used herein is the smallest unit of speech that distinguishes meaning or the basic unit of sound in a given language that distinguishes one word from another. An example of a phoneme would be the ‘t’ found in words like “tip”, “stand”, “writer”, and “cat”.

A “phonemic transcription” of a word is a representation of the word comprising a series of phonemes. For example, the initial sound in “cat” and “kick” may be represented by the phonemic symbol ‘k’ while the one in “circus” may be represented by the symbol ‘s’. Further, ‘ ’ is used herein to distinguish a symbol as a phonemic symbol, unless otherwise indicated. In contrast to a phonemic transcription of a word, the term “orthographic transcription” of the word refers to the typical spelling of the word.

The term “formant” as used herein is a peak in an acoustic frequency spectrum which results from the resonant frequencies of human speech. Vowels are distinguished quantitatively by the formants of the vowel sounds. Most formants are produced by tube and chamber resonance, but a few whistle tones derive from periodic collapse of Venturi effect low-pressure zones. The formant with the lowest frequency is called f1, the second f2, and the third f3. Most often the two first formants, f1 and f2, are enough to disambiguate the vowel. These two formants are primarily determined by the position of the tongue. f1 has a higher frequency when the tongue is lowered, and f2 has a higher frequency when the tongue is forward. Generally, formants move about in a range of approximately 1000 Hz for a male adult, with 1000 Hz per formant. Vowels will almost always have four or more distinguishable formants; sometimes there are more than six. Nasals usually have an additional formant around 2500 Hz.

The term “spectrogram” as used herein is a plot of the energy of the frequency content of a signal or energy spectral density of the speech signal as it changes over time. The spectrogram is calculated using a mathematical transform of windowed frames of a speech signal as a function of time. The horizontal axis represents time, the vertical axis is frequency, and the intensity of each point in the image represents amplitude of a particular frequency at a particular time. The diagram is typically reduced to two dimensions by indicating the intensity with color; in the present application the intensity is represented by gray scale.

### BRIEF SUMMARY

According to an aspect of the present invention there is provided a computerized method for speech recognition in a computer system. Reference word segments are stored in memory. The reference word segments when concatenated form spoken words in a language. Each of the reference word segments is a combination of at least two phonemes, including a vowel sound in the language. A temporal speech signal is input and digitized to produced a digitized temporal speech signal. The digitized temporal speech signal is transformed piecewise into the frequency domain to produce a time and frequency dependent transform function. The energy spectral density of the temporal speech signal is proportional to the absolute value squared of the transform function. The energy spectral density is cut into input time segments of the energy spectral density. Each of said input time segments includes at least two phonemes including at least one vowel sound of the temporal speech signal. For each of the input time segments, (i) a fundamental frequency is extracted from the energy spectral density during the input time segment, (ii) a target segment is selected from the reference segments and thereby a target energy spectral density of the target segment is input. A correlation between the energy spectral density during the time segment and the target energy spectral density of the target segment is performed after calibrating the fundamental frequency to the target energy spectral density thereby improving the correlation. The time-dependent transform function is preferably dependent on a scale of discrete frequencies. The calibration is performed by interpolating the fundamental frequency between the discrete frequencies to match the target fundamental frequency. The fundamental frequency and the harmonic frequencies of the fundamental frequency form an array of frequencies. The calibration is preferably performed using a single adjustable parameter which adjusts the array of frequencies, while maintaining the relationship between the fundamental frequency and the harmonic frequencies. The adjusting includes multiplying the frequency array by the target energy spectral density of the target segment thereby forming a product and adjusting the single adjustable parameter until the product is a maximum. The fundamental frequency typically undergoes a monotonic change during the input time segment. The calibrating preferably includes compensating for the monotonic change in both the input time segment and the reference word segment. The reference word segments are preferably classified into one or more classes. The correlation result from the correlation is input and used to select a second target segment from one or more of the classes. The classification of the reference word segments is preferably based on: the vowel sound(s) in the word segment, the relative time duration of the reference segments, relative energy levels of the reference segments, and/or on the energy spectral density ratio. The energy spectral density is divided into two or more frequency ranges, and the energy spectral density ratio is between two respective energies in two of the frequency ranges. Alternatively or in addition, the classification of the reference segments into classes is based on normalized peak energy of the reference segments and/or on relative phonetic distance between the reference segments.

According to another aspect of the present invention there is provided a computerized method for speech recognition in a computer system. Reference word segments are stored in memory. The reference word segments when concatenated form spoken words in a language. Each of the reference word segments is a combination of at least two phonemes. One or more of the phonemes includes a vowel sound in the language. The reference word segments are classified into one or more classes. A temporal speech signal is input and digitized to produced a digitized temporal speech signal. The digitized temporal speech signal is transformed piecewise into the frequency domain to produce a time and frequency dependent transform function. The energy spectral density of the temporal speech signal is proportional to the absolute value squared of the transform function. The energy spectral density is cut into input time segments of the energy spectral density. Each of said input time segments includes at least two phonemes including at least one vowel sound of the temporal speech signal. For each of the input time segments, a target segment is selected from the reference word segment and the target energy spectral density of the target segment is input. A correlation between the energy spectral density during the time segment and the target energy spectral density of the target segment is performed. The next target segment is selected from one or more of the classes based on the correlation result of the (first) correlation. The cutting of the energy spectral density segments into the input time segments is preferably based on at least two of the following signals: (i) autocorrelation in the time domain of temporal speech signal, (ii) average energy as calculated by integrating energy spectral density over frequency and (iii) normalized peak energy calculated by the peak energy as a function of frequency divided by the mean energy averaged over a range of frequencies.

For each of the input time segments, a fundamental frequency is preferably extracted from the energy spectral density during the input time segment. After calibrating the fundamental frequency to the target energy spectral density, the correlation is performed between the energy spectral density during the time segment and the target energy spectral density. In this way, the correlation is improved. The classification of the reference word segments is preferably based on: the vowel sound(s) in the word segment, the relative time duration of the reference segments, relative energy levels of the reference segments, and/or on the energy spectral density ratio. The energy spectral density is divided into two or more frequency ranges, and the energy spectral density ratio is between two respective energies in two of the frequency ranges. Alternatively or in addition, the classification of the reference segments into classes is based on normalized peak energy of the reference segments and/or on relative phonetic distance between the reference segments.

According to still other aspects of the present invention there are provided computer media encoded with processing instructions for causing a processor to execute methods of speech recognition.

The foregoing and/or other aspects are evidenced by the following detailed description in conjunction with the accompanying drawings.

### BRIEF DESCRIPTION OF THE DRAWINGS

The invention is herein described, by way of example only, with reference to the accompanying drawings, wherein:

FIG. 1 is a simplified general flow diagram of a speech recognition engine, according to an embodiment of the present invention;

FIG. 1A is a graph of a speech signal of the word segment ‘ma’, according to an embodiment of the present invention;

FIG. 1B illustrates a spectrogram of the digitized input speech signal of the words “How are you”, according to an embodiment of the present invention;

FIG. 1C illustrates a graph of energy spectral density for the peaks above threshold of the sound “o” in “how, according to an embodiment of the present invention;

FIG. 1D illustrates a graph of energy spectral density for the peaks above threshold of the sound ‘a’ in “are”, according to an embodiment of the present invention;

FIG. 2 is a flow diagram of a process for calibrating for tonal differences between the speaker of one or more input segments and the reference speaker(s) of the reference segments, according to an embodiment of the present invention;

FIG. 2A is a graph illustrating the frequency peaks of the input speech segment adjusted to correspond to the energy spectral density of the target segment, according to an embodiment of the present invention;

FIG. 2B is a graph illustrating energy spectral density of two different speakers saying ‘a’;

FIG. 2C is a graph illustrating an improved intercorrelation of corrected energy spectral density when energy spectral densities of both speakers of FIG. 2B are corrected;

FIG. 2D is a graph illustrating the monotonic variations of the fundamental frequencies over time of the two speakers of FIG. 2B while saying ‘a’, according to an embodiment of the present invention;

FIG. 2E is a graph illustrating the the correlation of the same speaker saying “a” at two different times after speaker calibration, according to an embodiment of the present invention;

FIG. 2F is a graph of energy spectral density for two different speakers saying the segment “yom”;

FIG. 2G is a graph of energy spectral densities FIG. 2F after speaker calibration, according to an embodiment of the present invention;

FIG. 3A-3D illustrate graphically fusion of multiple signals used during the cut segment procedure, according to embodiments of the present invention; and

FIG. 4. illustrates schematically a simplified computer system of the prior art.

### DETAILED DESCRIPTION

The principles and operation of a method according to the present invention, may be better understood with reference to the drawings and the accompanying description.

It should be noted, that although the discussion includes different examples the use of word segments in speech recognition in English, present invention may, by non-limiting example, alternatively be configured by applying the teachings of the present invention to other languages as well.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

The term “segment” or “word segment” as used herein refers to parts of words in a particular language. Word segments are generated by modeling the sounds of the language with a listing of vowel sounds and consonant sounds in the language and permuting the sounds together in pairs of sounds, sound triplets and sound quadruplets etc. as appropriate in the language. Word segments may include in different embodiments one, and/or more syllables. For instance, the word ending “-tion” is a two syllable segment appropriate in English. Many word segments are common to different languages. An exemplary list of word segments, according to an embodiment of the present invention is found in Table I as follows:

TABLE I
Listing of Word Segments in a language with five vowels and 18 consonants

double vowels 5 * 5
a ae ao ai au
ea e eo ei eu
oa oe o oi ou
ia ie io i iu
ua ue uo ui u
dual (consonant + vowel) 18 * 5
ba va ga da za Xa ta ja ka la ma na sa pa fa tsa Ra Sha
be ve ge de ze Xe te je ke le me ne se pe fe tse Re She
bi vi gi di zi Xi ti ji ki li mi ni si pi fi tsi Ri Shi
bo vo go do zo Xo to jo ko lo mo no so po fo tso Ro Sho
bu vu gu du zu Xu tu ju ku lu mu nu su pu fu tsu Ru Shu
dual (vowel + phoneme) 18 * 5
ab av ag ad az aX at aj ak al am an as af ap ats aR aSh
eb ev eg ed ez eX et ej ek el em en es ef ep ets eR eSh
ob ov og od oz oX ot oj ok ol om on os of op ots oR oSh
ib iv ig id iz iX it ij ik il im in is if ip its iR iSh
ub uv ug ud uz uX ut uj uk ul um un us uf up uts uR uSh
segments 18 * 5 * 18
bab bag bad bav baz baX bat baj bal bam ban bas baf bap bats bak
baR baSh
gab gag gad gav gaz gaX gat gaj gal gam gan gas gaf gap gats gak
gaR gaSh
dab dag dad dav daz daX dat daj dal dam dan das daf dap dats dak
daR daSh
vab vag vad vav vaz vaX vat vaj val vam van vas vaf vap vats vak vaR
vaSh
zab zag zad zav zaz zaX zat zaj zal zam zan zas zaf zap zats zak zaR
zaSh
Xab Xag Xad Xav Xaz XaX Xat Xaj Xal Xam Xan Xas Xaf Xap Xats
Xak XaR XaSh
tab tag tad tav taz taX tat taj tal tam tan tas taf tap tats tak taR taSh
jab jag jad jav jaz jaX jat jaj jal jam jan jas jaf jap jats jak jaR jaSh
lab lag lad lav laz laX lat laj lal lam lan las laf lap lats lak laR laSh
mab mag mad mav maz maX mat maj mal mam man mas maf map
mats mak maR maSh
nab nag nad nav naz naX nat naj nal nam nan nas naf nap nats nak
naR naSh
sab sag sad sav saz saX sat saj sal sam san sas saf sap sats sak saR
saSh
fab fag fad fav faz faX fat faj fal fam fan fas faf fap fats fak faR faSh
pab pag pad pav paz paX pat paj pal pam pan pas paf pap pats pak
paR paSh
tsab tsag tsad tsav tsaz tsaX tsat tsaj tsal tsam tsan tsas tsaf tsap
tsats tsak tsaR tsaSh
kab kag kad kav kaz kaX kat kaj kal kam kan kas kaf kap kats kak kaR
kaSh
Rab Rag Rad Rav Raz RaX Rat Raj Ral Ram Ran Ras Raf Rap Rats
Rak RaR RaSh
Shab Shag Shad Shav Shaz ShaX Shat Shaj Shal Sham Shan Shas
Shaf Shap Shats Shak ShaR ShaSh
beb beg bed bev bez beX bet bej bel bem ben bes bef bep bets
bek beR beSh
geb geg ged gev gez geX get gej gel gem gen ges gef gep gets
gek geR geSh
deb deg ded dev dez deX det dej del dem den des def dep dets
dek deR deSh
veb veg ved vev vez veX vet vej vel vem ven ves vef vep vets vek
veR veSh
zeb zeg zed zev zez zeX zet zej zel zem zen zes zef zep zets zek
zeR zeSh
Xeb Xeg Xed Xev Xez XeX Xet Xej Xel Xem Xen Xes Xef Xep Xets
Xek XeR XeSh
teb teg ted tev tez teX tet tej tel tem ten tes tef tep tets tek teR
teSh
jeb jeg jed jev jez jeX jet jej jel jem jen jes jef jep jets jek jeR
jeSh
leb leg led lev lez leX let lej lel lem len les lef lep lets lek leR
leSh
meb meg med mev mez meX met mej mel mem men mes mef mep
mets mek meR meSh
neb neg ned nev nez neX net nej nel nem nen nes nef nep nets
nek neR neSh
seb seg sed sev sez seX set sej sel sem sen ses sef sep sets sek
seR seSh
feb feg fed fev fez feX fet fej fel fem fen fes fef fep fets fek feR
feSh
peb peg ped pev pez peX pet pej pel pem pen pes pef pep pets
pek peR peSh
tseb tseg tsed tsev tsez tseX tset tsej tsel tsem tsen tses tsef tsep
tsets tsek tseR tseSh
keb keg ked kev kez keX ket kej kel kem ken kes kef kep kets kek
keR keSh
Reb Reg Red Rev Rez ReX Ret Rej Rel Rem Ren Res Ref Rep
Rets Rek ReR ReSh
Sheb Sheg Shed Shev Shez SheX Shet Shej Shel Shem Shen Shes
Shef Shep Shets Shek SheR SheSh
bob bog bod bov boz boX bot boj bol bom bon bos bof bop bots
bok boR boSh
gob gog god gov goz goX got goj gol gom gon gos gof gop gots
gok goR goSh
dob dog dod dov doz doX dot doj dol dom don dos dof dop dots
dok doR doSh
vob vog vod vov voz voX vot voj vol vom von vos vof vop vots vok
voR voSh
zob zog zod zov zoz zoX zot zoj zol zom zon zos zof zop zots zok
zoR zoSh
Xob Xog Xod Xov Xoz XoX Xot Xoj Xol Xom Xon Xos Xof Xop Xots
Xok XoR XoSh
tob tog tod tov toz toX tot toj tol tom ton tos tof top tots tok toR
toSh
job jog jod jov joz joX jot joj jol jom jon jos jof jop jots jok joR
joSh
lob log lod lov loz loX lot loj lol lom lon los lof lop lots lok loR
loSh
mob mog mod mov moz moX mot moj mol mom mon mos mof mop
mots mok moR moSh
nob nog nod nov noz noX not noj nol nom non nos nof nop nots
nok noR noSh
sob sog sod sov soz soX sot soj sol som son sos sof sop sots sok
soR soSh
fob fog fod fov foz foX fot foj fol fom fon fos fof fop fots fok foR
foSh
pob pog pod pov poz poX pot poj pol pom pon pos pof pop pots
pok poR poSh
tsob tsog tsod tsov tsoz tsoX tsot tsoj tsol tsom tson tsos tsof tsop
tsots tsok tsoR tsoSh
kob kog kod kov koz koX kot koj kol kom kon kos kof kop kots kok
koR koSh
Rob Rog Rod Rov Roz RoX Rot Roj Rol Rom Ron Ros Rof Rop
Rots Rok RoR RoSh
Shob Shog Shod Shov Shoz ShoX Shot Shoj Shol Shom Shon Shos
Shof Shop Shots Shok ShoR ShoSh
bib big bid biv biz biX bit bij bil bim bin bis bif bip bits bik biR
biSh
gib gig gid giv giz giX git gij gil gim gin gis gif gip gits gik giR
giSh
dib dig did div diz diX dit dij dil dim din dis dif dip dits dik diR
diSh
vib vig vid viv viz viX vit vij vil vim vin vis vif vip vits vik viR viSh
zib zig zid ziv ziz ziX zit zij zil zim zin zis zif zip zits zik ziR ziSh
Xib Xig Xid Xiv Xiz XiX Xit Xij Xil Xim Xin Xis Xif Xip Xits Xik XiR
XiSh
tib tig tid tiv tiz tiX tit tij til tim tin tis tif tip tits tik tiR tiSh
jib jig jid jiv jiz jiX jit jij jil jim jin jis jif jip jits jik jiR jiSh
lib lig lid liv liz liX lit lij lil lim lin lis lif lip lits lik liR liSh
mib mig mid miv miz miX mit mij mil mim min mis mif mip mits mik
miR miSh
nib nig nid niv niz niX nit nij nil nim nin nis nif nip nits nik niR
niSh
sib sig sid siv siz siX sit sij sil sim sin sis sif sip sits sik siR siSh
fib fig fid fiv fiz fiX fit fij fil fim fin fis fif fip fits fik fiR fiSh
pib pig pid piv piz piX pit pij pil pim pin pis pif pip pits pik piR
piSh
tsib tsig tsid tsiv tsiz tsiX tsit tsij tsil tsim tsin tsis tsif tsip tsits tsik
tsiR tsiSh
kib kig kid kiv kiz kiX kit kij kil kim kin kis kif kip kits kik kiR kiSh
Rib Rig Rid Riv Riz RiX Rit Rij Ril Rim Rin Ris Rif Rip Rits Rik
RiR RiSh
Shib Shig Shid Shiv Shiz ShiX Shit Shij Shil Shim Shin Shis Shif
Ship Shits Shik ShiR ShiSh
bub bug bud buv buz buX but buj bul bum bun bus buf bup buts
buk buR buSh
gub gug gud guv guz guX gut guj gul gum gun gus guf gup guts
guk guR guSh
dub dug dud duv duz duX dut duj dul dum dun dus duf dup duts
duk duR duSh
vub vug vud vuv vuz vuX vut vuj vul vum vun vus vuf vup vuts vuk
vuR vuSh
zub zug zud zuv zuz zuX zut zuj zul zum zun zus zuf zup zuts zuk
zuR zuSh
Xub Xug Xud Xuv Xuz XuX Xut Xuj Xul Xum Xun Xus Xuf Xup Xuts
Xuk XuR XuSh
tub tug tud tuv tuz tuX tut tuj tul tum tun tus tuf tup tuts tuk tuR
tuSh
jub jug jud juv juz juX jut juj jul jum jun jus juf jup juts juk juR
juSh
lub lug lud luv luz luX lut luj lul lum lun lus luf lup luts luk luR
luSh
mub mug mud muv muz muX mut muj mul mum mun mus muf mup
muts muk muR muSh
nub nug nud nuv nuz nuX nut nuj nul num nun nus nuf nup nuts
nuk nuR nuSh
sub sug sud suv suz suX sut suj sul sum sun sus suf sup suts suk
suR suSh
fub fug fud fuv fuz fuX fut fuj ful fum fun fus fuf fup futs fuk fuR
fuSh
pub pug pud puv puz puX put puj pul pum pun pus puf pup puts
puk puR puSh
tsub tsug tsud tsuv tsuz tsuX tsut tsuj tsul tsum tsun tsus tsuf tsup
tsuts tsuk tsuR tsuSh
kub kug kud kuv kuz kuX kut kuj kul kum kun kus kuf kup kuts kuk
kuR kuSh
Rub Rug Rud Ruv Ruz RuX Rut Ruj Rul Rum Run Rus Ruf Rup
Ruts Ruk RuR RuSh
Shub Shug Shud Shuv Shuz ShuX Shut Shuj Shul Shum Shun Shus
Shuf Shup Shuts Shuk ShuR ShuSh
Specific segments 220
segments: VOWEL(2)77
aRt agt alt ang ast bank baRt daRt dakt damt faks falt fast gaRt gaSt jalt jamt javt
kaRd kaRt kaSt kaft kamt kant kavt lamt lans laXt laft maRt maSt maXt mant nast
najX nant
pakt past paRk RaRt RaSt Ramt SaXt Salt Samt SaRt Savt saRt saft sakt samt taft
tavt tsaRt
tsalt vaXt vant XaRt XaSt XaXt Xakt Xalt Xant Xatst zavt
bejn bejt deks ejn meRt test josk disk ins Rist kuRs tuRk
segments: VOWEL(3)142
bga bla bRa bRak dRa dva kfaR kla klal knas kRa kta ktav ktsa kva kvaR pka pkak
plas pRa pSa sfa sgan slaX sma Ska SkaX Slav Sma Sna Sta Sva tna tnaj tsda tsfat
tsma zman
dmej gve kne kSe kte kve sde sme sRe sve Ske Sne Snei Snej Stej SXe tRem tsme
zke
bdi bli bni bRi bRit bXi dRi gli gvi kli kni kvi kviS kXi pgi pki pni pti
sgi sli smi snif svi sviv sXi Sgi Sli Smi Sni SRi Sti Svi Svil SXi tfi tmi
tni tXi tsvi tsRi zmi zRi
gdo kmo kRo kto mSoX pgoS pso smol spoRt stop Slo Smo SmoR Snot SXo tfos
tsfon tsXok
dRu gvul klum knu kvu kXu plus pnu pRu pSu ptu smu stud sXum Slu Smu Svu SXu
tmu tnu tRu tSu tXum zgu zXu
segments: VOWEL(4)1
StRu
End of Table I

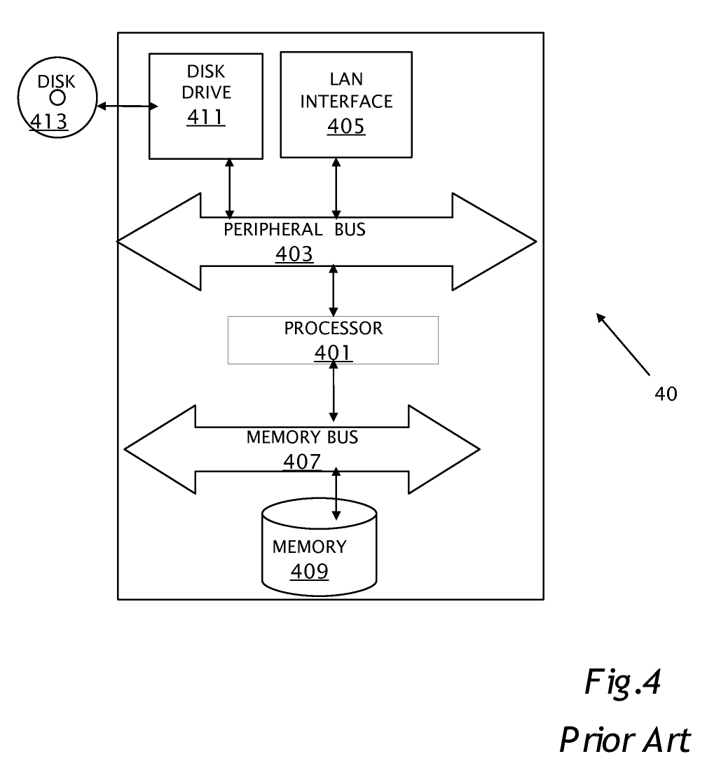

Reference is now made to FIG. 4 which illustrates schematically a simplified computer system 40. Computer system 40 includes a processor 401, a storage mechanism including a memory bus 407 to store information in memory 409 and a network interface 405 operatively connected to processor 401 with a peripheral bus 403. Computer system 40 further includes a data input mechanism 411, e.g. disk drive for a computer readable medium 413, e.g. optical disk. Data input mechanism 411 is operatively connected to processor 401 with peripheral bus 403.

Those skilled in the art will appreciate that the invention may be practiced with many types of computer system configurations, including mobile telephones, PDA's, pagers, hand-held devices, laptop computers, personal computers, multi-processor systems, microprocessor-based or programmable consumer electronics, network PCs, minicomputers, mainframe computers, and the like. The invention may also be practiced in distributed computing environments where local and remote computer systems, which are linked (either by hardwired links, wireless links, or by a combination of hardwired or wireless links) through a communication network, both perform tasks. In a distributed computing environment, program modules may be located in both local and remote memory storage devices.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

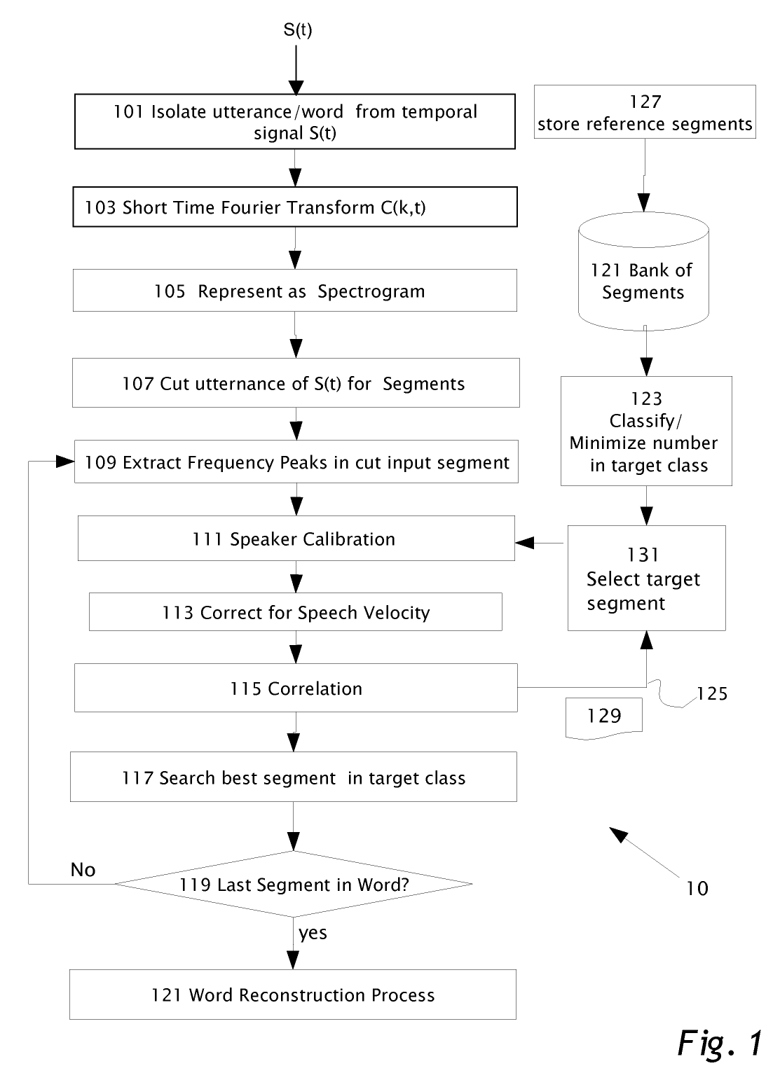

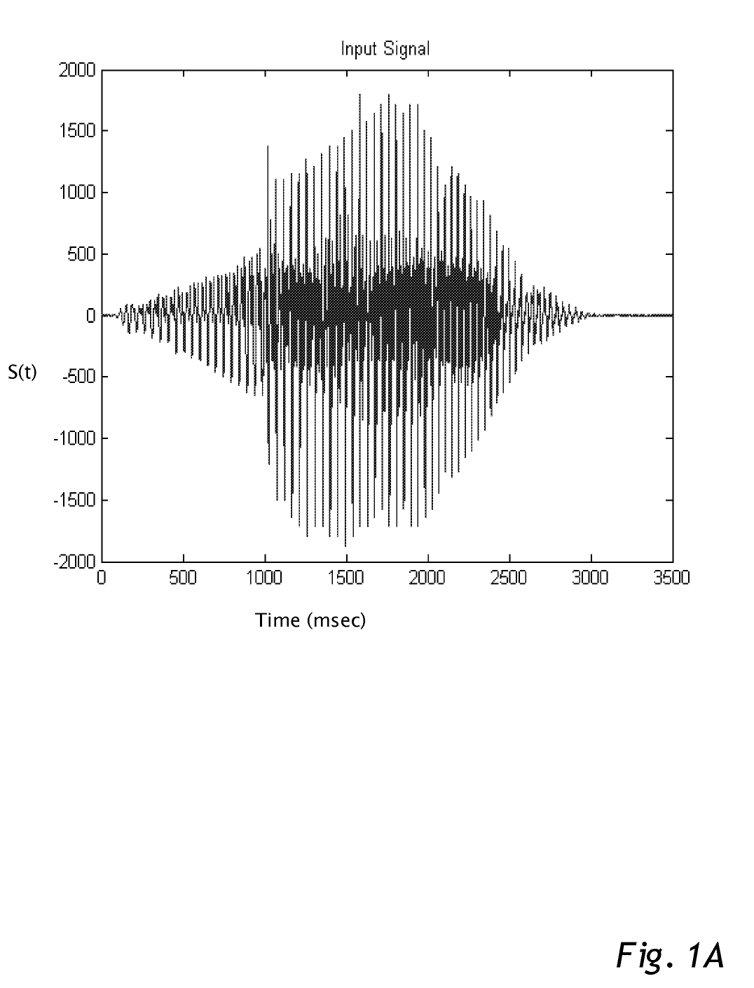

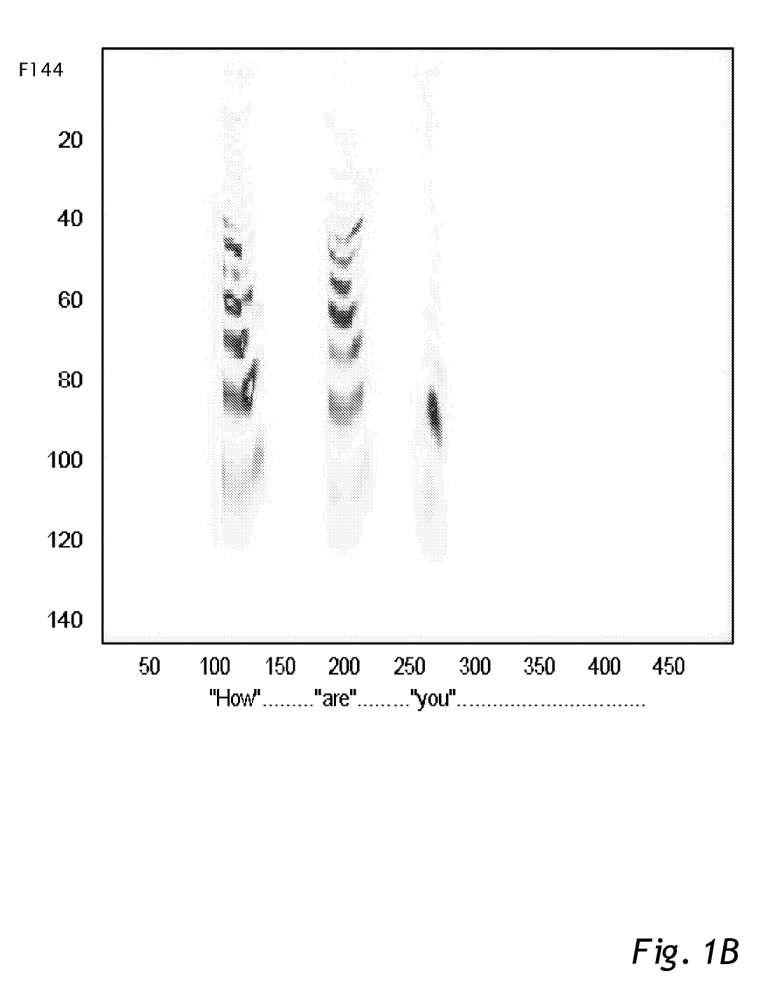

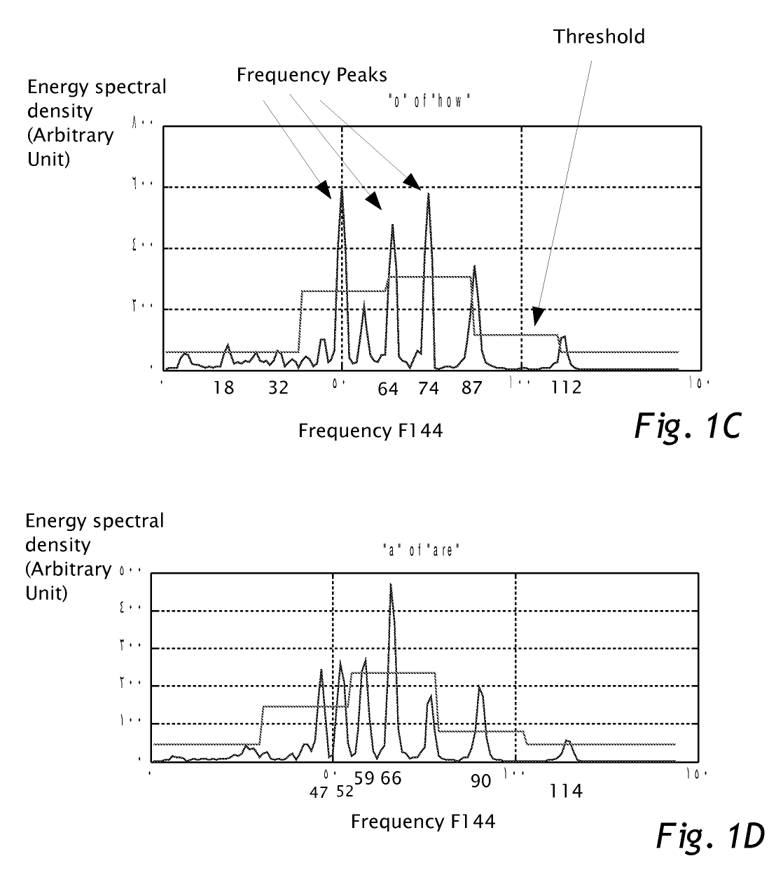

Reference is now made to FIG. 1, a simplified general flow diagram of a speech recognition engine 10, according to an embodiment of the present invention. A speech signal S(t) is input and digitized. In step 101, individual words, phrases or other utterances are isolated. An example of an isolated utterance of the word segment ‘ma’ is shown in the graph of FIG. 1A. Typically, the individual words are isolated when the absolute value of signal amplitude S(t) falls below one or more predetermined thresholds. An utterance isolated in step 101 may include several words slurred together for instance “How-are-you”. Any known method for isolating utterances from speech signal S(t) may be applied, according to embodiments of the present invention. In step 103, the digitized speech signal S(t) is transformed into the frequency domain, preferably using a short time discrete Fourier transform C(k,t) as follows in which k is a discrete frequency variable, w(t) is a window function,(sometimes known as a Hamming function) that is zero-valued outside of some chosen interval, n is a discrete time variable, N is the number of samples, e.g. 200 samples with duration 25 msec/sample. There is optionally an overlap e.g. 15 msec., between consecutive samples so that step between consecutive samples is 10 msec.

$$C ( k , t ) = {\sum }_{n = 1}^{N} ( S ( n ) ) \cdot w ( n - t ) \cdot exp ( - \frac{2 πi}{N} kn )$$

Alternatively, other discrete mathematical transforms, e.g. wavelet transform, may be used to transform the input speech signal S(t) into the frequency domain. The magnitude squared |C(k,t)|² of the transform C(k,t) yields a energy spectral density of the input speech signal S(t) which is optionally presented (step 105) as a spectrogram in a color image. Herein the spectrogram is presented in gray scale.

The discrete frequency k preferably covers several, e.g. 6, octaves of 24 frequencies or 144 frequencies in a logarithmic scale from 60 Hz to 4000 Hz. The logarithmic scale is an evenly tempered scale, as in a modern piano, 4000 Hz being chosen as the Nyquist frequency in telephony because the sampling rate in telephony is 8000 Hz. The term “F144” is used herein to represent the 144 logarithmic frequency scale of 144 frequencies. The frequencies of the F144 scale are presented in Table II as follows with 144 being the lowest frequency and 1 being the highest frequency.

TABLE II
The following table includes the 144 discrete
frequencies (kHz) in a logarithmic scale.

| F144 | k (kHz) |
|---|---|
| 144 | 0.065 |
| 143 | 0.067 |
| 142 | 0.069 |
| 141 | 0.071 |
| 140 | 0.073 |
| 139 | 0.076 |
| 138 | 0.078 |
| 137 | 0.080 |
| 136 | 0.082 |
| 135 | 0.085 |
| 134 | 0.087 |
| 133 | 0.090 |
| 132 | 0.093 |
| 131 | 0.095 |
| 130 | 0.098 |
| 129 | 0.101 |
| 128 | 0.104 |
| 127 | 0.107 |
| 126 | 0.110 |
| 125 | 0.113 |
| 124 | 0.117 |
| 123 | 0.120 |
| 122 | 0.124 |
| 121 | 0.127 |
| 120 | 0.131 |
| 119 | 0.135 |
| 118 | 0.139 |
| 117 | 0.143 |
| 116 | 0.147 |
| 115 | 0.151 |
| 114 | 0.156 |
| 113 | 0.160 |
| 112 | 0.165 |
| 111 | 0.170 |
| 110 | 0.175 |
| 109 | 0.180 |
| 108 | 0.185 |
| 107 | 0.190 |
| 106 | 0.196 |
| 105 | 0.202 |
| 104 | 0.208 |
| 103 | 0.214 |
| 102 | 0.220 |
| 101 | 0.226 |
| 100 | 0.233 |
| 99 | 0.240 |
| 98 | 0.247 |
| 97 | 0.254 |
| 96 | 0.262 |
| 95 | 0.269 |
| 94 | 0.277 |
| 93 | 0.285 |
| 92 | 0.294 |
| 91 | 0.302 |
| 90 | 0.311 |
| 89 | 0.320 |
| 88 | 0.330 |
| 87 | 0.339 |
| 86 | 0.349 |
| 85 | 0.360 |
| 84 | 0.370 |
| 83 | 0.381 |
| 82 | 0.392 |
| 81 | 0.404 |
| 80 | 0.415 |
| 79 | 0.428 |
| 78 | 0.440 |
| 77 | 0.453 |
| 76 | 0.466 |
| 75 | 0.480 |
| 74 | 0.494 |
| 73 | 0.508 |
| 72 | 0.523 |
| 71 | 0.539 |
| 70 | 0.554 |
| 69 | 0.571 |
| 68 | 0.587 |
| 67 | 0.605 |
| 66 | 0.622 |
| 65 | 0.641 |
| 64 | 0.659 |
| 63 | 0.679 |
| 62 | 0.699 |
| 61 | 0.719 |
| 60 | 0.740 |
| 59 | 0.762 |
| 58 | 0.784 |
| 57 | 0.807 |
| 56 | 0.831 |
| 55 | 0.855 |
| 54 | 0.880 |
| 53 | 0.906 |
| 52 | 0.932 |
| 51 | 0.960 |
| 50 | 0.988 |
| 49 | 1.017 |
| 48 | 1.047 |
| 47 | 1.077 |
| 46 | 1.109 |
| 45 | 1.141 |
| 44 | 1.175 |
| 43 | 1.209 |
| 42 | 1.245 |
| 41 | 1.281 |
| 40 | 1.319 |
| 39 | 1.357 |
| 38 | 1.397 |
| 37 | 1.438 |
| 36 | 1.480 |
| 35 | 1.523 |
| 34 | 1.568 |
| 33 | 1.614 |
| 32 | 1.661 |
| 31 | 1.710 |
| 30 | 1.760 |
| 29 | 1.812 |
| 28 | 1.865 |
| 27 | 1.919 |
| 26 | 1.976 |
| 25 | 2.033 |
| 24 | 2.093 |
| 23 | 2.154 |
| 22 | 2.218 |
| 21 | 2.282 |
| 20 | 2.349 |
| 19 | 2.418 |
| 18 | 2.489 |
| 17 | 2.562 |
| 16 | 2.637 |
| 15 | 2.714 |
| 14 | 2.794 |
| 13 | 2.876 |
| 12 | 2.960 |
| 11 | 3.047 |
| 10 | 3.136 |
| 9 | 3.228 |
| 8 | 3.322 |
| 7 | 3.420 |
| 6 | 3.520 |
| 5 | 3.623 |
| 4 | 3.729 |
| 3 | 3.839 |
| 2 | 3.951 |
| 1 | 4.067 |

FIG. 1B illustrates a spectrogram of the digitized input speech signal S(t) of the word “How are you”. The abscissa is a time scale in milliseconds with 10 msec per pixel. The ordinate is the F144 frequency scale.

A property of spectrogram |C(k,t)|² is that the fundamental frequency and harmonics Hₖ of the speech signal may be extracted (step 109, FIG. 1) Reference is now made to FIG. 1C which illustrates a graph of energy spectral density |C(k,t)|² for the peaks of the sound “o” in “how”. The threshold is based on or equal to a local average over frequency. The harmonic peaks Hₖ (above “threshold”) for the sound “o” are in F144 frequency scale (Table II) are:

| | F144 | | | | | | |
|---|---|---|---|---|---|---|---|
| | 18 | 32 | 50 | 64 | 74 | 87 | 112 |
| ratio to k₀ | 15.10 | 10.08 | 5.99 | 4.00 | 3.00 | 2.06 | 1 |

Using the table of Table II it is determined that the fundamental frequency is 0.165 kHz. corresponding to 112 on the F144 frequency scale and the other measured peaks fit closely to integral multiples of the fundamental frequency k₀ as shown in the table above. Similarly the harmonic peaks of the sound “a” from the sound “are” may be extracted as integral multiples of the fundamental frequency which is 114 on the F144 scale. The peaks above “threshold” in the graph of FIG. 1D are listed in the table below along with the integral relation between the fundamental frequency and its harmonics.

F144

| | 47 | 52 | 59 | 66 | 90 | 114 |
|---|---|---|---|---|---|---|
| ratio to k₀ | 6.92 | 5.99 | 4.90 | 3.00 | 2.00 | 1 |

As illustrated in the examples above, each sound or phoneme as spoken by a speaker is characterized by an array of frequencies including a fundamental frequency and harmonics Hₖ which have frequencies at integral multiples of the fundamental frequency, and the energy of the fundamental and harmonics.

During speech recognition, according to embodiments of the present invention, word segments are stored (step 127) in a bank 121 of word segments which have been previously recorded by one or more reference speakers. In order to perform accurate speech recognition, sounds or word segments in the input speech signal S(t) are calibrated (step 111) for a tonal difference between the fundamental frequency (and harmonics derived therefrom) and the fundamental frequency (and harmonics) of the reference word segments previously stored (step 127) in bank 121 of segments. Reference word segments are stored (step 127) in bank 121 in either in the time domain (in analog or digital format) or in the frequency domain (for instance as reference spectrograms)

Speaker calibration (Step 111)

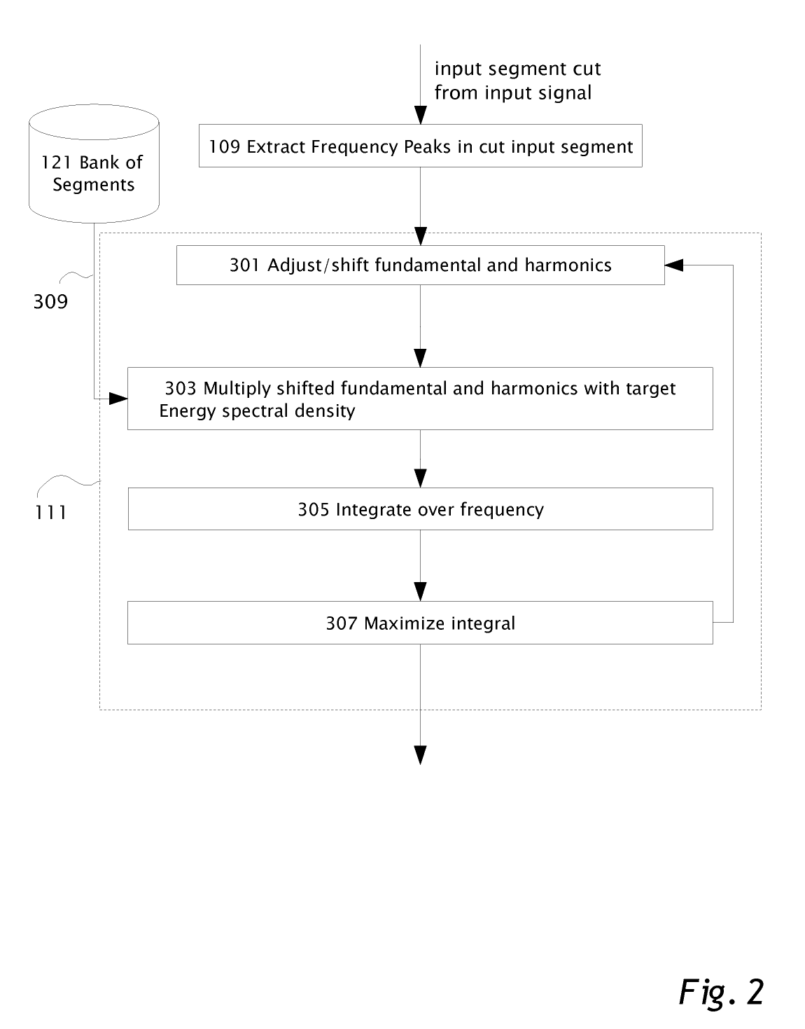

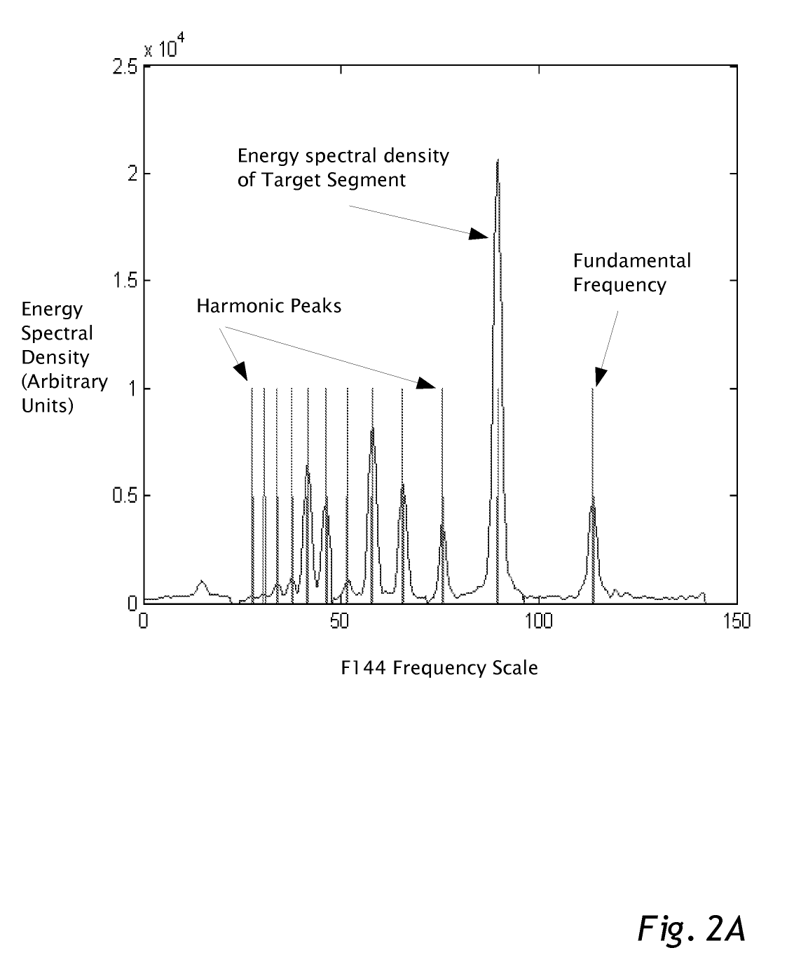

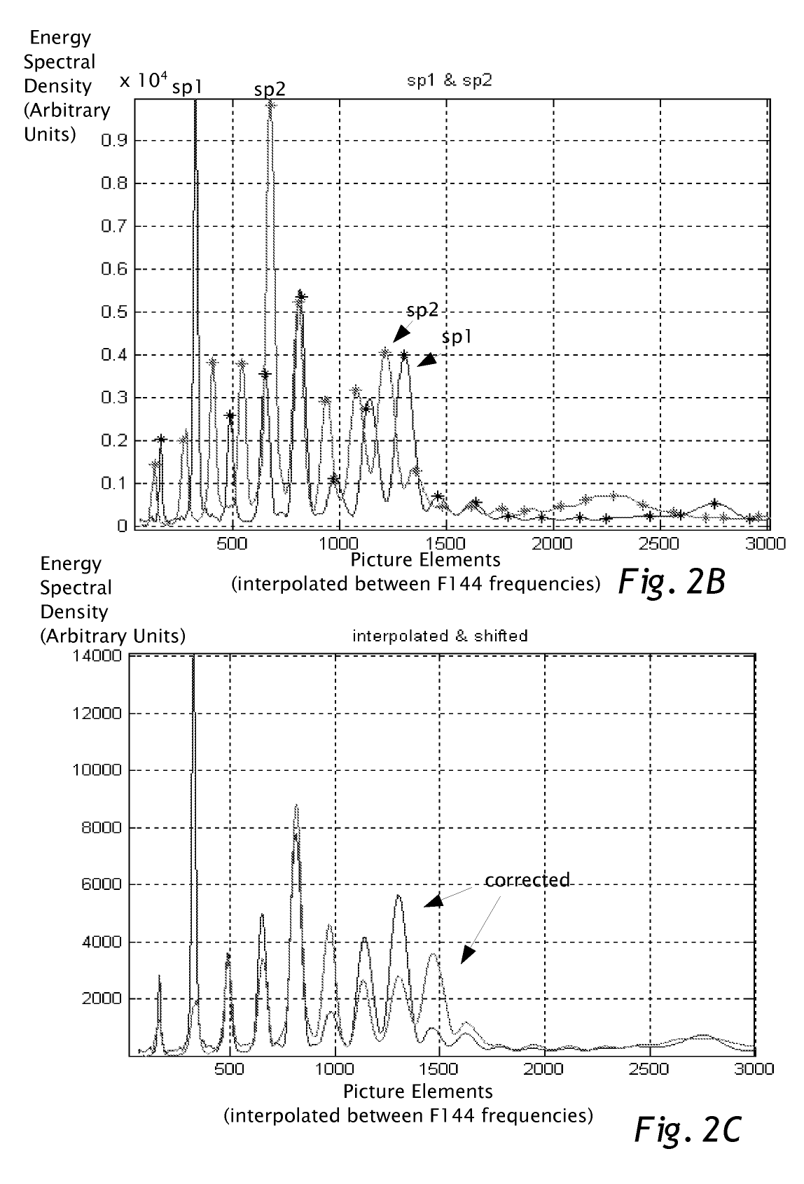

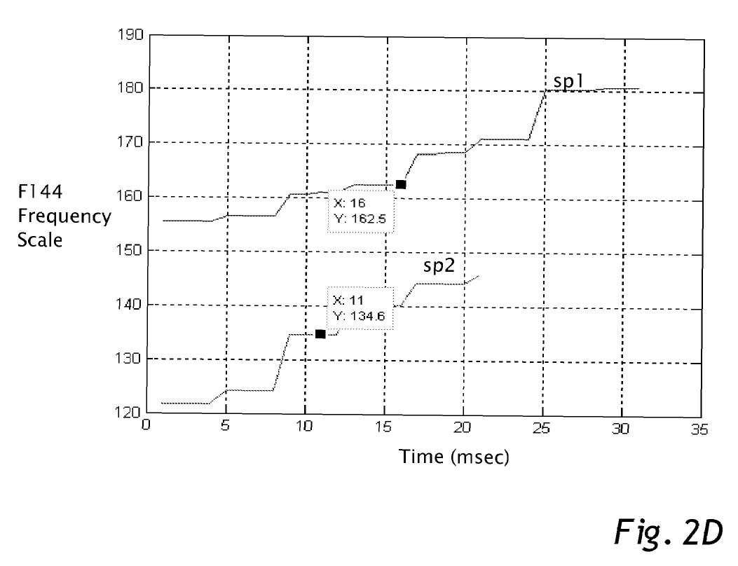

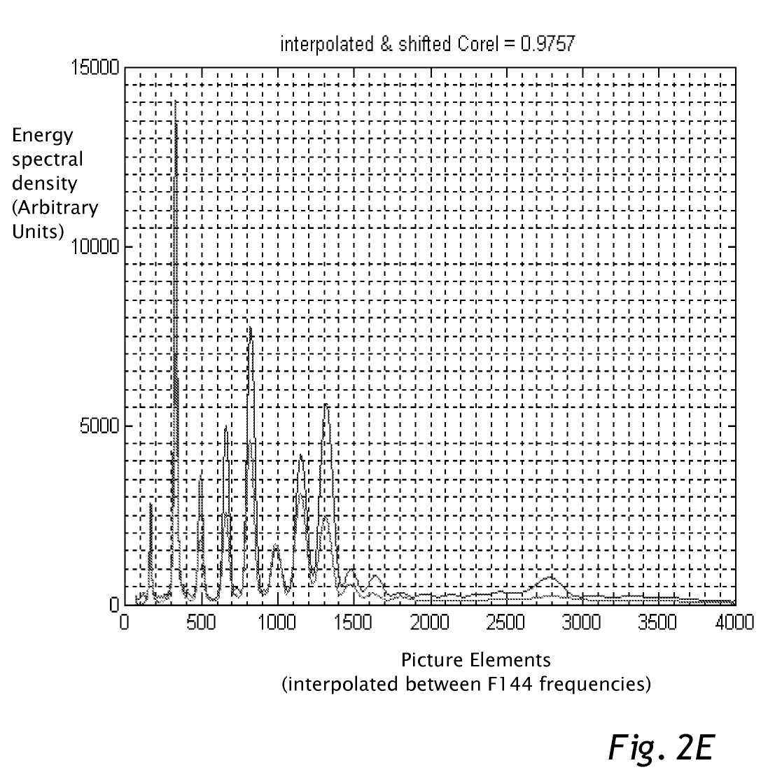

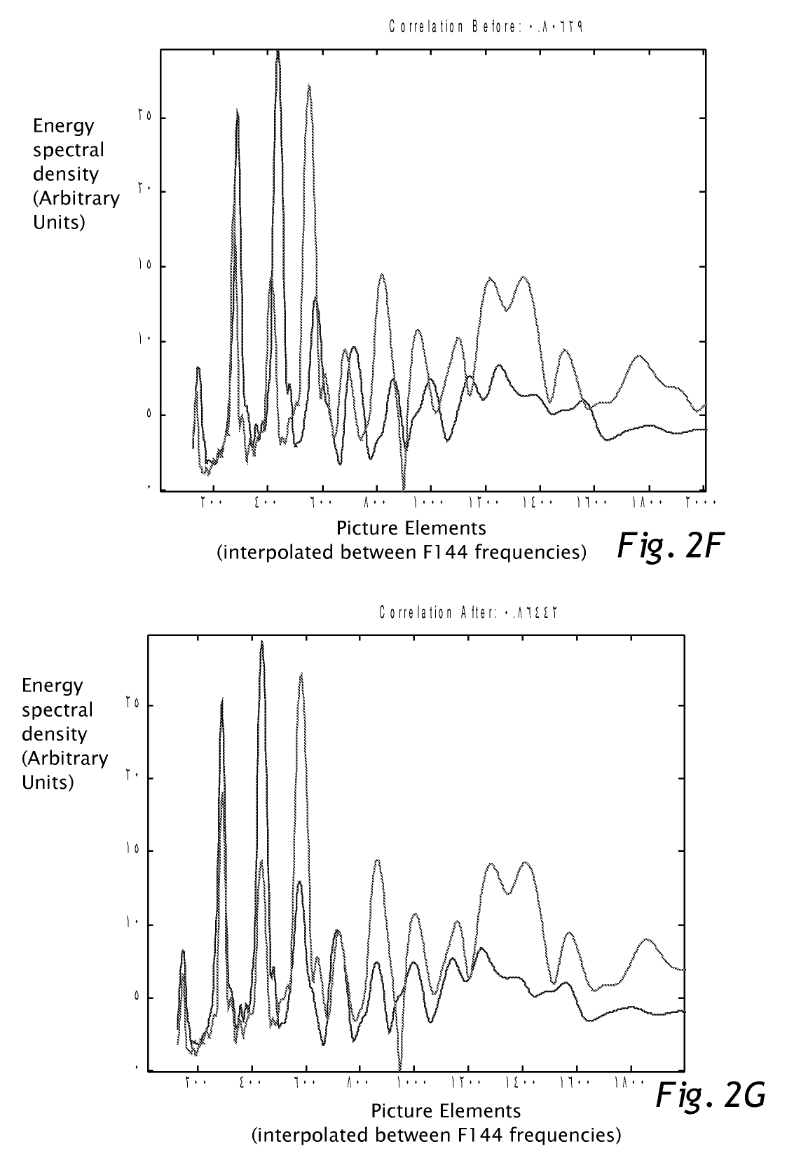

Reference is now also made to FIG. 2, a flow diagram of a process for calibrating (step 111) for tonal differences between the speaker of one or more input segments and the reference speaker(s) of the reference segments stored in bank 121 of segments, according to an embodiment of the present invention. An input segment is cut (step 107) from input speech signal S(t). Frequency peaks including the fundamental frequency and its harmonics are extracted (step 109). A target segment as stored in bank 121 is selected (step 309). The energy spectral density |C(k,t)|² of the target segment is multiplied by the array of frequency peaks and the resulting product is integrated over frequency. With a single adjustable parameter, maintaining the relationships between the fundamental frequency and its harmonics, the fundamental frequency as extracted (step 109) from the input segment is adjusted, thereby modifying the frequencies of the array of frequency peaks including the fundamental frequency and its harmonics. The fundamental frequency and corresponding harmonics of the input segment are adjusted together using the single adjustable parameter, multiplied (step 303) by the energy spectral density of the target segment, the integral over frequency of the product is recalculated (step 305) and maximized (step 307).

According to an embodiment of the present invention, speaker calibration (step 111) is preferably performed using image processing on the spectrogram. The array of frequency peaks from the input segment are plotted as horizontal lines intersecting the vertical frequency axis of the spectrogram of the target segment. Typically, a high resolution along the vertical frequency axis, e.g. 4000 picture elements (pixels), is used. The frequency peaks, i.e. horizontal lines are shifted vertically, thereby adjusting (step 301) the fundamental frequency of the energy spectral density of the input segment to maximize (step 307) the integral. Interpolation of the pixels between the 144 discrete frequencies of the F144 frequency scale is used to precisely adjust (step 301) the fundamental frequency. FIG. 2A illustrates the frequency peaks of the input speech segment adjusted (step 301) to correspond to the energy spectral density of the target segment thereby maximizing the integral (step 307).

The fundamental frequency (and its harmonics) typically varies even when the same speaker speaks the same speech segment at different times. Furthermore, during the time the speech segment is spoken, there is typically a monotonic variation of fundamental frequency and its harmonics. Correcting for this monotonic variation within the segment using step 111 allows for accurate speech recognition, according to embodiments of the present invention.

Reference is now made to FIGS. 2B, 2C and 2D, according to an embodiment of the present invention. FIG. 2B illustrates energy spectral density of two different speakers saying ‘a’. FIG. 2D illustrates the monotonic variations of the fundamental frequencies of the two speakers of FIG. 2B. FIG. 2C illustrates an improved intercorrelation of corrected energy spectral density when energy spectral densities of both speakers of FIG. 2B are corrected (step 111) for fundamental frequency, and for the monotonic variations.

According to an embodiment of the present invention, reference segments are stored (step 127) as reference spectrograms with the monotonic tonal variations removed along the time axis, ie. fundamental frequency of the respective reference segments during the segment are flattened. Alternatively, the reference spectrograms are stored (step 127) with the original tonal variations and the tonal variations are removed “on the fly” prior to correlation.

### Correlation (Step 115)

Correlation (step 115) between energy spectral densities may be determined using any method known in the art. Correlation (step 115) between the energy spectral densities is typically determined herein using a normalized scalar product. The normalization is used to removed differences in speech amplitude between the input segment and target segment under comparison.

In FIG. 2E, the correlation of the the same speaker saying “a” at two different times in correlated after speaker calibration (step 111) The correlation calculated is 97.6%. In FIG. 2F, energy spectral density is graphed for two different speakers saying the segment “yom”. In FIG. 2G, the energy spectral densities of FIG. 2F are corrected (step 111). The correction improves the correlation from 80.6% to 86.4%.

### Speech Velocity Correction (Step 113)

Another advantage of the use of a spectrogram for speech recognition is that the spectrogram may be resized, without changing the time scale or frequencies in order to compensate for differences in speech velocity between the input segment cut (step 107) from the input speech signal S(t) and the target segment selected from bank 121 of segments. Correlation (step 115) is preferable performed after resizing the spectrogram, i.e. after speech velocity correction step 113).

### Cut for Segments (Step 107)

According to embodiments of the present invention, an input segment are first isolated or cut (step 107) from the input speech signal and subsequently the input segment is correlated (step 115) with one of the reference segments previously stored (step 127) in bank 121 of segments. The cut segment procedure (step 107) is preferably based on one or more of, or two or more of, or all of three signals as follows:
(i) autocorrelation in time domain of the speech signal S(t)
(ii) average energy as calculated by integrating energy spectral density |C(k,t)|² over frequency k;
(iii) normalized peak energy: The spectral structure which is calculated by the peak energy as a function of k divided by the mean energy for all frequencies k.

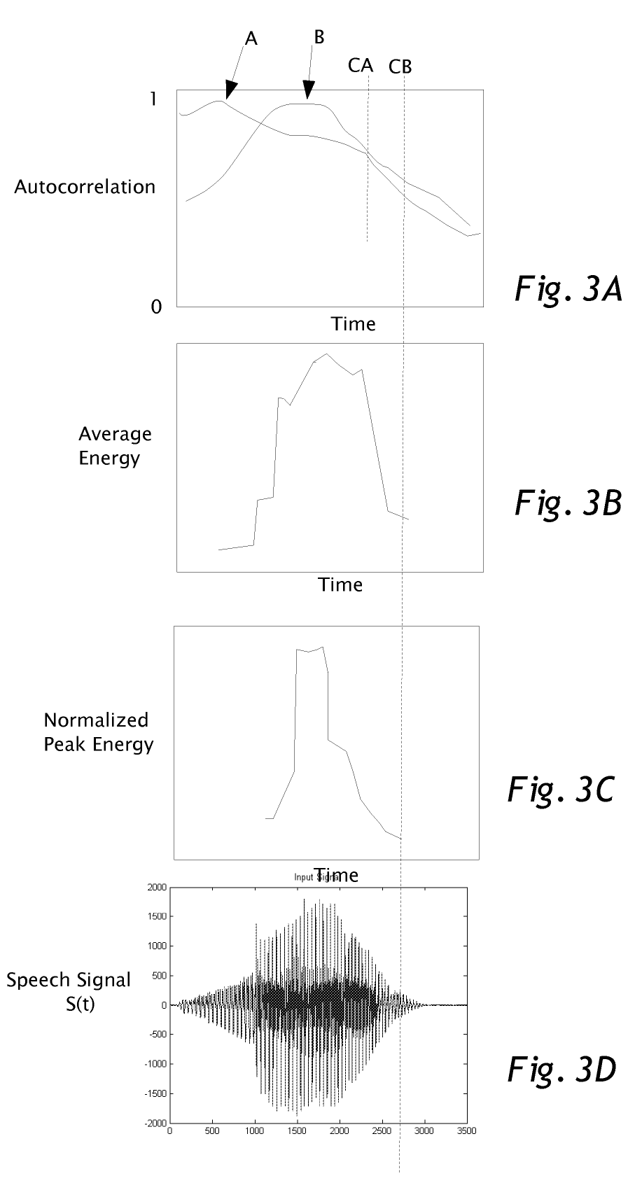

Reference is made now made to FIGS. 3A-3D, which illustrate graphically the cut segment procedure, (step 107) according to embodiments of the present invention. The graphs of FIGS. 3A-3D include approximately identical time scales for intercomparison. FIG. 3D is an exemplary graph of a speech signal of word segment ‘ma’, the graph identical to that of FIG. 1A with the scale changed to correspond with the time scale of the other graphs of FIGS. 3A-3C. FIG. 1A includes a representative graph showing approximately the autocorrelation of the input speech signal, FIG. 1B and FIG. 1C include respective representative graphs showing approximately, the average energy and the spectral structure. In FIG. 1A, trace A illustrates a first autocorrelation calculation <S(0)S(Δt)> of a input word segment of speech signal S(t) referenced at the beginning of the word segment, e.g. t=0. Hence, trace A is well correlated in the beginning of the segment and the autocorrelation decreases throughout the duration of the segment. When the autocorrelation falls below 90% and/or the slope of the autocorrelation is higher than a given value, then a candidate time CA for cutting the segment (step 107) is suggested. A vertical line shows a candidate time CA for cutting the segment based on autocorrelation trace A. A plateau or smoothly decreasing portion of trace A is selected as a new reference and the autocorrelation is preferably recalculated as illustrated in trace B, based on the reference timed in the selected plateau in the middle of the input speech segment. A vertical line shows an improved time CB for cutting the segment based on autocorrelation trace B, pending validation after consideration of the other two signals, (ii) energy and (iii) normalized peak energy. A comparison of time cut CB on both the average energy graph (FIG. 3B) and the normalized peak energy graph (FIG. 3C) indicate that the time CB is consistent with those two signals also and therefore a cut at time CB is valid. The three signals may be “fused” into a single function with appropriate weights in order to generate a cut decision based on the three signals.

### Classification/Minimize Number of Elements in Target Class (Step 123)

According to embodiments of the present invention, correlation (step 115) is performed for all the word segments in a particular language, for instance as listed in Table I. However, in order to improve speech recognition performance in real time, the segments stored in bank 121 are preferably classified in order to minimize the number of elements that need to be correlated (step 115). Classification (step 123) may be performed using one or more of the following exemplary methods:

Vowels: Since all word segments include at least one vowel, (double vowels include two vowels) an initial classification may be performed based on the vowel. Typically, vowels are distinguishable quantitatively by the presence of formants. In the word segments of Table I, four classes of vowels may be distinguished {‘a’}, {‘e’}, {‘i’}, {‘o’, ‘u’}. The sounds ‘o’, and ‘u’ are placed in the same class because of the high degree of confusion between them

Duration: The segments stored in bank 121 may be classified into segments of short and long duration. For instance, for a relatively short input segment, the segments of short duration are selected first for correlation (step 115).

Energy: The segments stored in bank 121 are classified based on energy. For instance, two classes are used based on high energy (strong sounds) or weak energy (weak sounds). As an example, the segment ‘ma’ is strong and ‘ni’ is weak.

Energy spectral density ratio: The segments stored in bank 121 are classified based on the energy spectral density ratio. The energy spectral density is divided by into two frequency ranges, an upper and lower frequency range and a ratio between the respective energies in the two frequency ranges is used for classification (step 123)

Normalized peak energy: The segments stored in bank 121 are classified based on normalized peak energy. The segments with high normalized peak energy level typically include all vowels and some consonants {‘m’,‘n’, ‘t’, ‘z’, ‘r’}

Phonetic distance between segments: Relative phonetic distance between may be used to classify (step 123) the segments. The term “phonetic distance” as used herein referring to two segments, segment A and segment B is a relative measure of how difficultly the two segments are confused by a speech recognition engine, according to embodiments of the present invention. For a large “phonetic distance” there is a small probability of recognizing segment A when segment B is input to the speech recognition engine and similarly there is small probability of the recognizing segment B when segment A is input. For a small “phonetic distance” there is a relatively large probability of recognizing segment A when segment B is input to the speech recognition engine and similarly there is relatively large probability of the recognizing segment B when segment A is input. Phonetic distance between segments is determined by the similarity between the sounds including in the segments and the order of the sounds in the segments. The following exemplary groups of sounds are easily confused” {‘p’,‘t’,‘k’}, {‘b’,‘d’,‘v’}, {‘j’,‘i’,‘e’}, {‘f’,‘s’}, {‘z’,‘v’}, {‘Sh’, ‘X’} {‘ts’, ‘t’,‘s’}, {‘m’,‘n’,‘l’}The ‘S’ symbol is similar to in English “sh” as in “Washington”. The ‘X’ sound is the voiceless velar fricative, “ch” as in the German composer Bach.

Pitch: The segments may be classified (step 123) based on tonal qualities or pitch. For instance, the same segment may appear twice in bank 121 once recorded in a man's voice and also in a women's voice.

Referring back to FIG. 1, classification (step 123) is preferably performed again by inputting (step 125) the correlation value 129 into a selection algorithm (step 131. Once a comparatively high correlation result 129 is found between a particular reference segment and the input segment, another target segment is selected (step 131) which is phonetically similar or otherwise classified similarly to the particular reference segment with a high correlation. Conversely, if the correlation result 129 is low, a phonetically different target segment is selected or a target segment which does not share a class with the first target segment of low correlation result 129. In this way the number of reference segments used and tested is reduced. Generally, the search process (step 117) converges to one or a few of the target segments selected as the best segment(s) in the in the target class. If speech recognition engine 10 is processing in series, and there are more segments to process, then the next segment is input (decision box 119) into step 109 for extracting frequency peaks. Otherwise, if all the segments in the utterance/word have been processed (decision box 119), a word reconstruction process (step 121) is initiated similar to and based on for instance hidden Markov Models known in the prior art. In word reconstruction process, individual phonemes are optionally used (if required) in combination with the selected word segments.

While the invention has been described with respect to a limited number of embodiments, it will be appreciated that many variations, modifications and other applications of the invention may be made.

What is claimed is:

1. A computerized method for speech recognition in a computer system, the method comprising the steps of:
(a) storing a plurality of reference word segments, wherein said reference word segments when concatenated form a plurality of spoken words in a language; wherein each of said reference word segments is a combination of at least two phonemes including at least one vowel sound in said language;
(b) inputting and digitizing a temporal speech signal, thereby producing a digitized temporal speech signal;
(c) transforming piecewise said digitized temporal speech signal into the frequency domain, thereby producing a time and frequency dependent transform function; wherein the the energy spectral density of said temporal speech signal is proportional to the absolute value squared of said transform function;
(d) cutting the energy spectral density into a plurality of input time segments of the energy spectral density; wherein each of said input time segments includes at least two phonemes including at least one vowel sound of the temporal speech signal; and
(e) for each of said input time segments;
(i) extracting a fundamental frequency from the energy spectral density during the input time segment;
(ii) selecting a target segment from the reference word segments thereby inputting a target energy spectral density of said target segment;
(iii) performing a correlation between the energy spectral density during said time segment and said target energy spectral density of said target segment after calibrating said fundamental frequency to said target energy spectral density thereby improving said correlation.

2. The computerized method, according to claim 1, wherein said time-dependent transform function is dependent on a scale of discrete frequencies, wherein said calibrating is performed by interpolating said fundamental frequency between said discrete frequencies to match the target fundamental frequency.

3. The computerized method, according to claim 1, wherein said fundamental frequency and at least one harmonic frequency of said fundamental frequency form an array of frequencies, wherein said calibrating is performed using a single adjustable parameter which adjusts said array of frequencies, maintaining the relationship between the fundamental frequency and said at least one harmonic frequency, wherein said adjusting includes:
(A) multiplying said frequency array by the target energy spectral density of said target segment thereby forming a product; and
(B) adjusting said single adjustable parameter until the product is a maximum.

4. The computerized method, according to claim 1, wherein said fundamental frequency undergoes a monotonic change during the input time segment, wherein said calibrating includes compensating for said monotonic change.

5. The computerized method, according to claim 1, further comprising the step of:
(f) classifying said reference word segments into a plurality of classes;
(g) inputting a correlation result of said correlation;
(h) second selecting a second target segment from at least one of said classes based on said correlation result.

6. The computerized method, according to claim 5, wherein said classifying said reference word segments into classes is based on said at least one vowel sound.

7. The computerized method, according to claim 5, wherein said classifying said reference word segments into classes is based on relative time duration of said reference word segments.

8. The computerized method, according to claim 5, wherein said classifying said reference word segments into classes is based on relative energy levels of said reference word segments.

9. The computerized method, according to claim 5, wherein said classifying said reference word segments into classes is based on energy spectral density ratio, wherein said energy spectral density is divided by into at least two frequency ranges, and said energy spectral density ratio is between the respective energies in said at least two frequency ranges.

10. The computerized method, according to claim 5, wherein said classifying said reference word segments into classes is based on normalized peak energy of said reference word segments.

11. The computerized method, according to claim 5, wherein said classifying said reference word segments into classes is based on relative phonetic distance between said reference word segments.

12. A computerized method for speech recognition in a computer system, the method comprising the steps of:
(a) storing a plurality of reference word segments, wherein said reference word segments when concatenated form a plurality of spoken words in a language; wherein each of said reference word segments is a combination of at least two phonemes including at least one vowel sound in said language;
(b) classifying said reference word segments into a plurality of classes;
(c) inputting and digitizing a temporal speech signal, thereby producing a digitized temporal speech signal;
(d) transforming piecewise said digitized temporal speech signal into the frequency domain, thereby producing a time and frequency dependent transform function; wherein the the energy spectral density of said temporal speech signal is proportional to the absolute value squared of said transform function;
(e) cutting the energy spectral density into a plurality of input time segments of the energy spectral density; wherein each of said input time segments includes at least two phonemes including at least one vowel sound of the temporal speech signal;
(f) for each of said input time segments:
(i) selecting a target segment from the reference word segments thereby inputting a target energy spectral density of said target segment;
(ii) performing a correlation between the energy spectral density during said time segment and said target energy spectral density of said target segment;
(g) based on a correlation result of said correlation, second selecting a second target segment from at least one of said classes.

13. The computerized method, according to claim 12, wherein said cutting is based on at least two signals selected from the group consisting of:
(h) autocorrelation in time domain of temporal speech signal;
(ii) average energy as calculated by integrating energy spectral density over frequency;
(iii) normalized peak energy calculated by the peak energy as a function of frequency divided by the mean energy averaged over a range of frequencies.

14. The computerized method, according to claim 12,
(h) for each of said input time segments;
(i) extracting a fundamental frequency from the energy spectral density during the input time segment;
(ii) performing said correlation between the energy spectral density during said time segment and said target energy spectral density of said target segment after calibrating said fundamental frequency to said target energy spectral density thereby improving said correlation.

15. The computerized method, according to claim 12, wherein said classifying said reference word segments into classes is based on said at least one vowel sound.

16. The computerized method, according to claim 12, wherein said classifying said reference word segments into classes is based on relative time duration of said reference word segments

17. The computerized method, according to claim 12, wherein said classifying said reference word segments into classes is based on relative energy levels of said reference word segments.

18. The computerized method, according to claim 12, wherein said classifying said reference word segments into classes is based on energy spectral density ratio, wherein said energy spectral density is divided into at least two frequency ranges, and said energy spectral density ratio is between the respective energies in said at least two frequency ranges.

19. The computerized method, according to claim 12, wherein said classifying said reference word segments into classes is based on normalized peak energy of said reference word segments.

20. The computerized method, according to claim 12, wherein said classifying said reference word segments into classes is based on relative phonetic distance between said reference word segments.

21. A computer readable medium encoded with processing instructions for causing a processor to execute the method of claim 1.

22. A computer readable medium readable encoded with processing instructions for causing a processor to execute the method of claim 12.
